(19) United States
(12) Patent Application Publication
(10) Pub. No.: US 2012/0218217 A1
(43) Pub. Date: Aug. 30, 2012

(54) METHOD FOR THREE-DIMENSIONAL SUPPORT OF THE MANUAL OPERATION OF GRAPHICAL USER INTERFACES

(76) Inventor: Peter Brügger, Muttenz (CH)

(21) Appl. No.: 13/505,944

(22) PCT Filed: Oct. 28, 2010
(86) PCT No.: PCT/EP10/66396

§ 371 Date: May 3, 2012

(30) Foreign Application Priority Data
Nov. 4, 2009 (CH) 01701/09

(51) Int. Cl. G06F 3/041; G09G 5/00

(52) U.S. Cl. 345/173; 345/156

(57) ABSTRACT

The present invention relates to the operation of a device having a graphical display operated by hand or using a stylus, characterized in that a graphical interaction is generated on said display analogous to the three-dimensional position of the hand or the stylus as soon as said hand or stylus is located in the immediate vicinity of said display. This concerns a system that supports the operator in manipulating graphical user interfaces in a three-dimensional form, such that an optical reaction takes place on the existing graphical application as soon as the operator approaches, said optical reaction reflecting an analogous function to the position of the finger or the stylus. The user interface reacts at the position where the finger of the user approaches, whereby the image curves, for example, as seen through a sphere. The closer the finger, the stronger is the effect, until finally contact with the surface executes the prescribed action.

Nowadays, operating computer systems comprising graphical user interfaces often takes place via so-called touch screens which, upon touching the screen with the finger or a stylus, triggers an interaction prescribed at the respective position. Such systems are widely used today in the industry, for example for operating controllers, (operator panels), but also on portable devices, e.g. in the field of mobile communication.

In the field of industrial applications, the operator is often focused at the same time on the machine or plant in order to monitor the real reaction of his/her interactions. It is therefore very important that these user interfaces are kept simple and clear so that it is still possible to reliably operate said user interfaces if the user has also to concentrate on other objects. From this point of view it is therefore desirable that the user receives feedback on his his/her actions through as many channels of his/her perception and senses as possible because thereby, he/she can carry out the operation faster and more reliable.

In contrast to an already known technology for operating through gestures and movements of the user, the present case is concerned with a completely different approach. This is not about interpreting more complex motion sequences (gestures) of the user over potentially relatively greater distances and to associate these gestures with different functions, but to three-dimensionally localize objects moving into the close vicinity of the screen and to immediately generate a corresponding reaction which shall serve for informing the user about what will happen if he/she comes closer to the screen and finally touches the same.

Understood in the meaning of this operating philosophy are already known devices which use haptic feedback which, upon contacting a surface of the screen linked to a function, triggers a vibration of the device which can be felt by the user.

In this direction, the described invention intends to achieve a further improvement of user friendliness by expanding the operating sense by the third dimension.

The desired effect can additionally be supported through acoustic signals which, likewise analogous to approaching, vary a sound effect. Depending on the function programmed at the position in question, the sound effect can be selected differently so that the user can distinguish in a purely acoustic manner which function will be triggered by his/her keystroke.

If the touch screen is operated from the side, it is usually more difficult for the operator to estimate the position of his/her finger relative to the surface. Here too, this system helps because the user interface provides continuously objective optical feedback which precisely describes the position of the finger relative to the sought function.

Besides the above-described function for supporting the positioning of the finger, further functions are also possible. From PC programs, so-called tooltips have been known for a long time, which open like tabs over a function if the user moves his/her cursor over it. On touch screen systems, this function is rarely used because no reliable differentiation can be made between the mousemove or mouseup/mousedown events that are usual on the PC. In order to make a mousemove, the user first has to touch the screen which automatically generates a mousedown. By means of this three-dimensional method, these events and associated effects can now also be used for touch screens without any problems.

Another aspect and advantage of the three-dimensional method for operating is that today's commonly used touch systems which, e.g., function electromechanically or capacitively, can be replaced on demand. Many of these methods require a further film over the display which negatively affects the display quality of the same.

### OPERATION

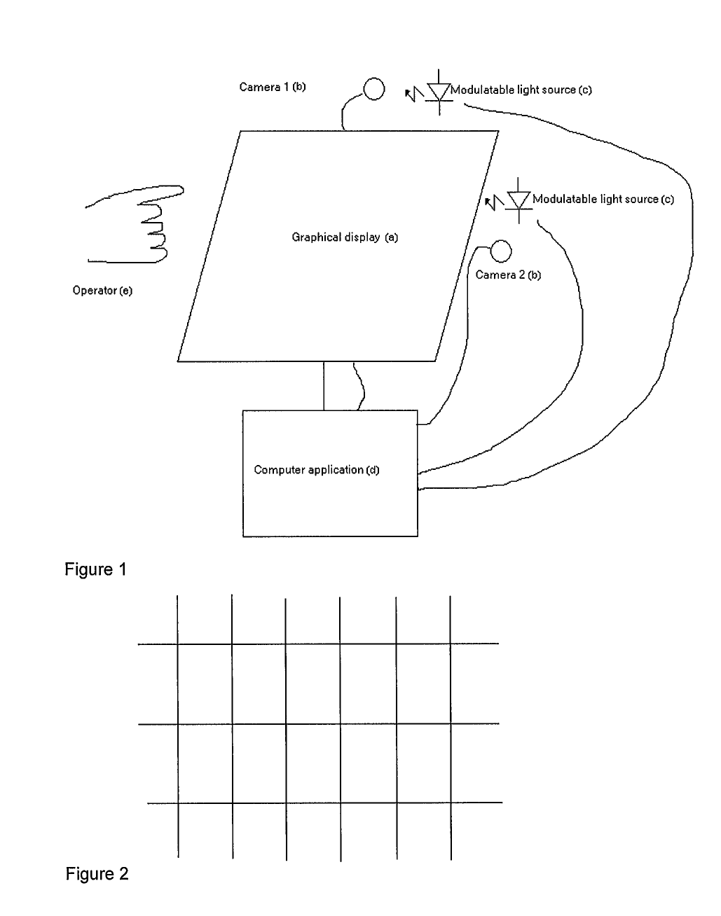

FIG. 1 shows an advantageous embodiment of this invention using two cameras (b). An operator (e) interacts with a graphical application (man-machine interface) which is illustrated by means of a computer (d) on a graphical display (a). Operating takes place, e.g., with a finger or a stylus. The cameras (b), the modulatable light sources (c) as well as the display (a) are connected to the computer application (d) and are also controlled by the latter. As soon as the operator (e) approaches, e.g. with his/her finger, the display (a), the operator is detected by the cameras (b) and his/her three-dimensional position in relation to the display (a) is calculated by means of the computer application (d). The image displayed through the computer application is now changed in relation to the position of the operator.

FIG. 2 shows schematically a possible graphical display. As soon as the operator (e) approaches said display, the image is changed accordingly at this position.

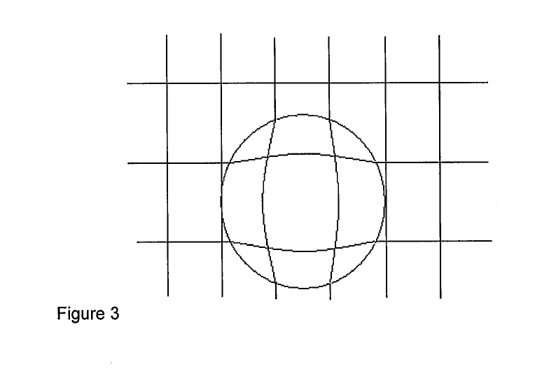

FIG. 3 shows a possible optical change. The degree of this change is greater the closer the operator approaches the display with his/her finger. Said change moves horizontal, vertical, parallel to the movement of the user.

The three-dimensional analysis of the position of the finger or stylus takes place in an advantageous configuration with two cameras (b) which can be attached laterally on the display. An advantageous embodiment of this object is carried out in such a manner that the cameras (b) are attached to the side of the monitor, in each case offset by 90 degrees, thus e.g., on top and on the right side. Moreover, this system can be supported by modulatable light sources (c) attached in the vicinity of the cameras. These light sources can operate in the infrared range in order not to disturb the operator. The light sources (e.g. LEDs) are cyclically switched on for capturing an image and switched off again for the next image. This method allows a simple extraction of disturbing objects in the visual field of the camera which are far away. Thus, an approaching object is initially well illuminated and is no longer illuminated in the next image, which simplifies the image analysis considerably. The configuration of the cameras offset by 90 degrees in turn allows using algorithms for the three-dimensional position determination that are simpler than the ones that would be required in the case of an arrangement side by side or to the left/right of the screen. This, e.g., is of importance for keeping the cost for such a system as low as possible because due to the low complexity of image processing, less demanding requirements in terms of computing capacity of the respective system are necessary and therefore, simpler hardware can be used.

Another field of use of such camera-based operating sensors can be seen in the sector of operator units which are placed entirely and protected as good as possible behind a glass panel. These units are used in areas where high robustness is required, e.g., against vandalism, or also in areas (food sector, laboratory, medical field) where the devices are easily to be cleaned with chemicals and mechanical auxiliary means (water, steam, high pressure, etc.), or in highly contaminated areas. Thus, the camera together with the display can be placed behind the protective glass panel. In order to prevent problems which could occur through contamination, these cameras can be implemented redundantly. As already described, monitoring is performed from two sides; however, it is possible to position a plurality of cameras staggered next to each other on each side. In this manner it is possible to calculate partial contaminations on the glass surface.

### SUMMARY OF THE ADVANTAGES

User interfaces become more interactive due to an optical reaction as soon as the hand approaches and therefore are easier to operate for the user.

Also, this technology simplifies operating small objects on the screen or to display more information on small, high-resolution screens and to operate the same.

1. A method for operating a device having a graphical display operated by hand or using stylus, characterized in that a graphical interaction is generated on the control panel of said display analogous to the three-dimensional position of the hand or the stylus as soon as said hand or stylus is located in the immediate vicinity of said display.

2. The method according to claim 1, characterized in that the evaluation of said three-dimensional position is also used for generating mousemove events without the need to touch the screen.

3. The method according to claim 1, characterized in that the graphical functions described in claim 1 are supported in an analogous manner by sound effects.

4. An arrangement according to claim 1, characterized in that the use of the claims described in 1 takes place in the field of machine and plant operation.

5. The method and arrangement according to claim 1, characterized in that the analysis of said three-dimensional position takes place via two camera systems which, in an advantageous configuration, are attached to the side of a monitor.

6. The method and arrangement according to claim 1, characterized in that the analysis of said three-dimensional position takes place via more than the two camera systems in order to compensate disturbances, e.g. due to contamination of the optics, by means of a redundant configuration.

7. The method and arrangement according to claim 5, characterized in that the two camera system, the cameras are offset by 90 degrees.

8. The method and arrangement according to claim 5, characterized in that the two camera system further includes modulatable lighting.
